(19) United States
(12) Patent Application Publication
(10) Pub. No.: US 2006/0130016 A1
(43) Pub. Date: Jun. 15, 2006

(54) Method of kernal-mode instruction interception and apparatus therefor

(76) Inventor: John R. Wagner, Melbourne, FL (US)

Correspondence Address: IP STRATEGIES, 12 1/2 WALL STREET, SUITE I, ASHEVILLE, NC, 28801, US

(21) Appl. No.: 11/286,274

(22) Filed: Nov. 23, 2005

Related U.S. Application Data
(63) Continuation-in-part of application No. 10/390,397, filed on Mar. 17, 2003.
(60) Provisional application No. 60/631,115, filed on Nov. 26, 2004.
(60) Provisional application No. 60/642,467, filed on Jan. 6, 2005.
(60) Provisional application No. 60/709,220, filed on Aug. 17, 2005.

(51) Int. Cl. G06F 9/45

(52) U.S. Cl. 717/136; 717/138

(57) ABSTRACT

A process of kernel-mode instruction interception on a host CPU includes copying CPU-executed instructions to respective new locations in memory, and transferring CPU control to the copied instructions for execution.

### CROSS-REFERENCE TO RELATED DOCUMENTS

This document claims the priority benefit, and incorporates by reference in its entirety, U.S. Provision Patent Application No. 60/631,115, which was filed on Nov. 26, 2004; and of U.S. Provision Patent Application No. 60/642,467, which was filed on Jan. 6, 2005; and of U.S. Provisional Patent Application No. 60/709,220, which was filed on Aug. 17, 2005. This is also a continuation-in-part of U.S. patent application Ser. No. 10/390,397, which was filed on Mar. 17, 2003.

### FIELD OF THE INVENTION

The present invention relates to software monitoring, testing, and analysis.

### BACKGROUND OF THE INVENTION

Processes for monitoring software behavior have many applications in both offensive and defensive cyberwarfare and also in software testing/debugging. Whenever intelligence about an application needs to be gathered, the behavior of the application is monitored and conclusions are drawn by analyzing the results.

When the source code of the application is available, one can monitor the behavior of the application on an instruction-by-instruction basis. Such monitoring allows the behavior to be better understood for the purposes of reengineering or debugging. Access to the source code allows exposure of all relevant information about the software's behavior, both external behavior and internal behavior. This includes calls to external components and the parameters of these calls, calls to internal components and the parameters of these calls, internally stored data, and control structures.

However, when the source code is not available, one must work with only the compiled binary of the application (for example, the executable, library or component). This means that only the machine code is available for analysis. As such it is much more difficult to get the detailed information that source debuggers can get.

Conventional systems include technology to intercept external behavior such as calls to the operating system or third party components. This technique is called system call interception. Conventional techniques also include the use of disassemblers to extract certain bits of internal information, but disassembly is a painstaking process fraught with trial and error. In general, information inside the binary executes without scrutiny and with no opportunity to intervene to change behavior in any predictable fashion. Internal functions, stored data, and individual control statements can be unreachable externally.

System call interception has many uses, including use in proactive antivirus tools and testing/debugging tools. However, there are many behaviors that escape such external scrutiny. For example, instructions that call exception handlers or interrupts execute without making system calls and can bypass monitoring or protective software.

A conventional solution to intercept such dispatch mechanisms is to insert code into the operating system kernel that detects these dispatches and notifies the monitoring application. There is a disadvantage to this solution in that because the actual operating system kernel is modified, every single application is intercepted instead of just the application being monitored, and such “kernel mode” solutions tend to destabilize the operating system.

Therefore, there is a need for an improved software monitoring solution. User-mode instruction interception has been used as an alternative to conventional methods, with excellent results. According to user-mode instruction interception, a program is executed in a controlled environment by first initiating execution of an operating system with which the program is adapted to execute. Redirection logic is inserted at the beginning of the program, and the program is executed such that the redirection logic is executed. A current instruction pointer is stored, and execution control is redirected to a program loader. The program loader selects a first block of instructions of the program, based at least in part on the stored current instruction pointer. This selected block of instructions is manipulated to provide a first phantom instruction block, which is executed in the controlled environment. This manipulation includes copying at least a portion of the selected first block to form the first phantom instruction block.

However, user-mode instruction interception is incapable of debugging or analyzing any kernel-mode device drivers that might be part of the product under test. Also, conventional instruction interception implementations are unable to monitor and modify code written as a kernel driver, or to effectively monitor communication between multiple processes. Further, a conventional user-mode instruction interception process is detectable by using a kernel-mode driver, that is, it can be detected by watching a process from the kernel, where it does not have any authority.

It would be advantageous for a process to provide all of the features found in user-mode instruction interception as well as the capability to debug or analyze all code running in the system, including kernel-mode drivers and the kernel itself. It would also be advantageous for an instruction intercept process to be undetectable by, for example, controlling both the drivers and the OS kernel, and for the process to accept plug-ins to perform customizable instruction-level instrumentation on any part of the system. It would also be advantageous for an instruction intercept process to intercept the operating system itself, so it has full control over the processor. It would also be advantageous for an instruction intercept process to allow all of the conventional user-mode instruction interception features to be used on kernel-mode drivers and operating system kernels. It would also be advantageous for an instruction intercept process to monitor or modify communications with existing hardware devices, and emulate hardware that is not present in the actual system. It would also be advantageous for an instruction intercept process to change the behavior of the CPU to test changes or additional instructions, and to simulate the feature sets of other classes of CPUs, without any changes to the host processor and even if the host processor does not support the features being requested. It would also be advantageous for an instruction intercept process to modify an operating system kernel in an undetectable way, even if it has anti-tampering in place, and to debug or analyze kernel-mode components with anti-debugging in place.

### BRIEF SUMMARY OF THE INVENTION

The present invention is a process of kernel-mode instruction interception on a host CPU. The process includes copying CPU-executed instructions to respective new locations in memory, and transferring CPU control to the copied instructions for execution.

All control transfer instructions can be modified to perform the copying and transferring.

The copied instructions can be modified. For example, it can be the case that the copied instructions are modified only when instructed by a process plug-in. In addition, the copied instructions can be modified as directed by a process plug-in.

The process of the invention can be run in a 64-bit mode of a CPU. The copied instructions can include first and second copies of guest operating system address space, such that the first copy of guest operating system address space is utilized for user pages and the second copy of guest operating system address space is utilized for kernel pages. An I/O device can be accessed, for example, by recompiling, in an exception handler, code accessing the device, and calling into the exception handler directly.

The copied instructions can include recompiled code. The recompiled code can be stored in code cache. The process can also include looking for a control transfer destination in the code cache. Execution can be transferred to the recompiled code in the code cache, if the control transfer destination is found in the code cache.

The copying and transferring actions can take place on a per-instruction basis at runtime. The copied code can be simplified during runtime.

The process can also include intercepting a branching instruction executed by an application and executing the intercepted branching instruction. At least one of a node and an edge for a destination block of code for the intercepted branching instruction can be created if either a node or an edge does not already exist. Any existing node for a destination block of code for the intercepted branching instruction can be split if the destination block is in the middle of the existing node.

The process can also include selecting a CPU on which to execute the copied instructions. It can then be determined if the instructions are supported by the selected CPU type and if the instructions are supported by the host CPU. An instruction exception can be issued and exception handling can continue, if the instruction is not supported by the target CPU type. The operation of the instructions can be emulated if the instructions are supported by the target CPU type and the instruction is not supported by the host CPU.

The process can also include writing destinations of branching instructions to a text file, and writing the address of the branching instruction to the text file. A compiler can be executed, an executable image can be provided, and the executable image and the text file can be passed to the compiler. Intermediate language code can be produced based on the executable image and the text file, with destination locations of the branching instructions resolved. The intermediate language code can then be converted to a higher-level source code document.

### BRIEF DESCRIPTION OF THE DRAWINGS

The present invention is illustrated by way of example and not limitation in the figures of the accompanying drawings, in which:

FIG. 1 is a flow diagram illustrating an exemplary process of the invention.

FIG. 2 shows an exemplary detail of an instruction manipulation action according to the invention.

FIG. 3 shows an exemplary detail of a phantom instruction execution action according to the invention.

FIG. 4 is a flow diagram illustrating another exemplary process of the invention.

FIG. 5 is a flow diagram showing yet another exemplary process of the invention.

FIG. 6 is a block diagram showing exemplary code execution under instruction interception according to the present invention.

FIG. 7 is a block diagram showing a comparison of exemplary 32-bit and 64-bit implementations of kernel-mode instruction interception according to the present invention.

FIG. 8 is a block diagram showing exemplary actions for handling of memory-mapped I/O according to the present invention.

FIG. 9 is a block diagram showing exemplary actions for control transfer and cache operation in instruction interception according to the present invention.

FIG. 10a is an exemplary schematic illustrating obfuscated code.

FIG. 10b is an exemplary schematic illustrating the result of transformation of simple control flow obfuscation.

FIG. 11 shows exemplary “do nothing” code sequences.

FIG. 12 shows exemplary transformations of obscure code equivalents.

FIG. 13a is an exemplary schematic showing flattened code.

FIG. 13b is an exemplary schematic showing transformed flattened code.

FIG. 14 is a flow diagram showing an exemplary branch processing action.

FIG. 15 shows an example of functional group grouping and collapsing.

FIG. 16 shows an example of adding comments to a basic block.

FIG. 17 shows exemplary breakpoints and single-stepping within a graph view.

FIG. 18 shows execution count displayed as a tooltip.

FIG. 19 is a diagram showing an exemplary process of handling of instructions.

FIG. 20 shows an exemplary CPU-selection user interface.

FIG. 21 is a block diagram showing an overview of a dynamic decompilation process.

### DETAILED DESCRIPTION OF THE INVENTION

User Mode

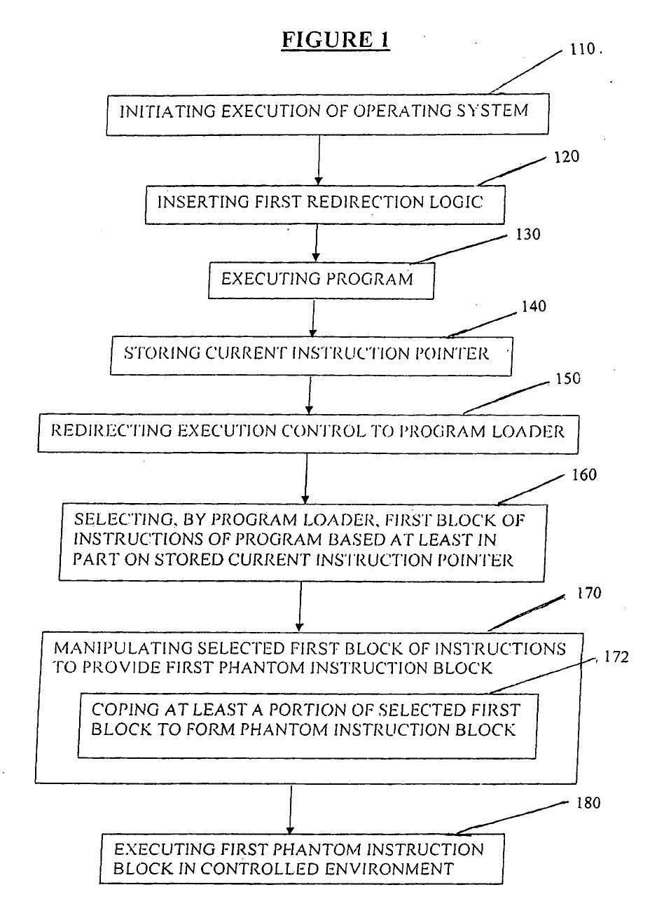

FIG. 1 illustrates an exemplary aspect of the invention, which will be referred to herein generally as Instruction Interception. As shown, a method of executing a program in a controlled environment includes initiating execution of an operating system with which the program is adapted to execute 110, inserting redirection logic at the beginning of the program 120, and executing the program such that the redirection logic is executed 130. Further, a current instruction pointer is stored 140, and execution control is redirected to a program loader 150. The program loader selects a first block of instructions of the program 160, based at least in part on the stored current instruction pointer. This selected block of instructions is manipulated to provide a first phantom instruction block 170, which is executed in the controlled environment 180. This manipulation includes copying at least a portion of the selected first block to form the first phantom instruction block 172. Thus, controlled execution of the program (or selected block or blocks) is achieved by executing a phantom block or phantom blocks. As shown, the original program itself is not executed; instead, a phantom copy of the program (a phantom block or blocks of instructions) is executed.

It should be noted that the selected first block of instructions can include one or more instructions. That is, although referred to as a block, the selected block can be a single instruction, or it can include multiple instructions.

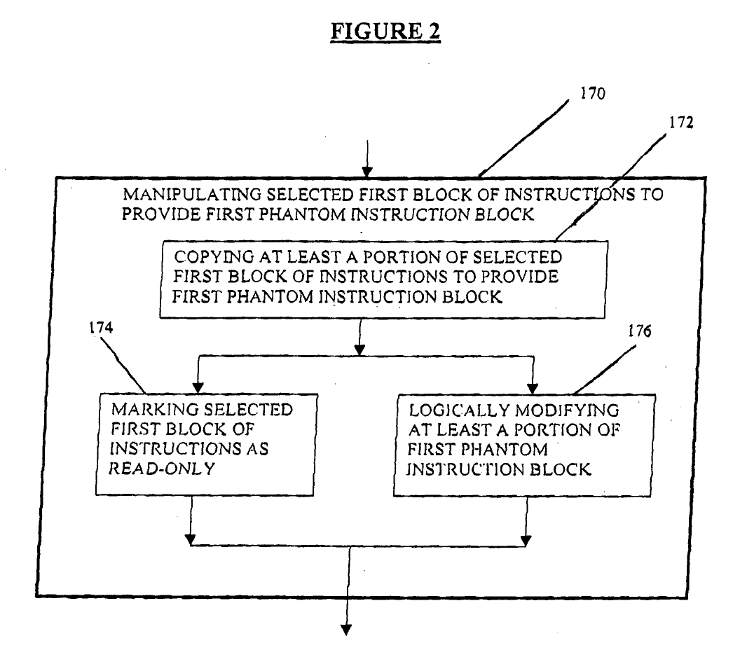

As shown in FIG. 2, the manipulation of the selected block of instructions 170 can also include marking the selected first block as read-only 174, or logically modifying at least a portion of the first phantom instruction block 176, or both. By marking the selected first block as read-only 174, the risk that self-modifying code will modify a previously selected block of instructions is avoided, so as to ensure, for example, that program control is not lost. In turn, logically modifying at least a portion of the first phantom instruction block 176 can include any one or combination of inserting program logic into the first phantom instruction block, deleting program logic from the first phantom instruction block, and changing program logic in the first phantom instruction block.

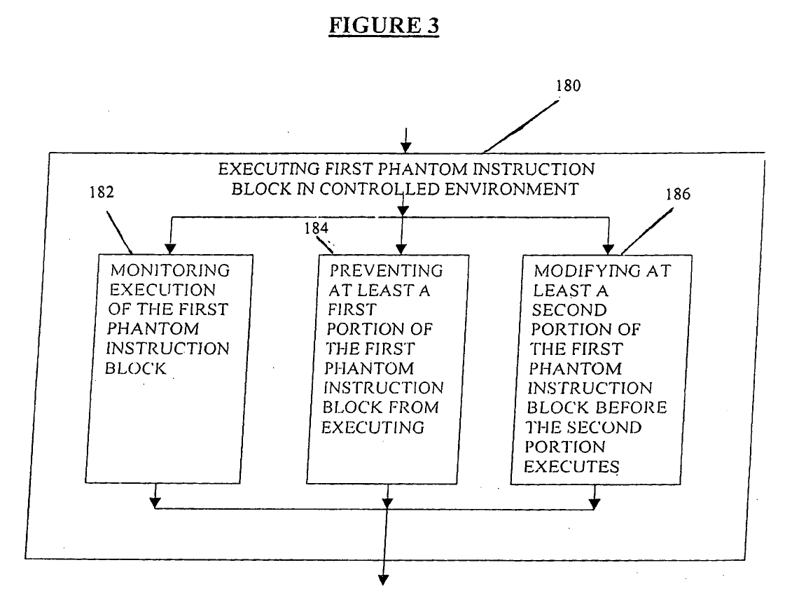

As illustrated in FIG. 3, execution of the first phantom instruction block in the controlled environment 180 can include any one or combination of monitoring execution of the first phantom instruction block 182, preventing at least a first portion of the first phantom instruction block from executing 184, and modifying at least a second portion of the first phantom instruction block before the second portion executes 186. The controlled environment can include a user interface by which a user can execute and monitor execution of the first phantom instruction block, such as monitoring the values of system and/or program variables and states, and system memory, as well as other system or program states and conditions. According to another exemplary aspect of the invention, a user interface can provide a “debugging” environment, with which a user can execute, monitor, modify and/or prevent execution of one or more instructions contained in a phantom instruction block. According to another exemplary aspect of the invention, a user interface can allow a user to trace and step through, on an instruction-by-instruction basis, the one or more instructions contained in a phantom instruction block. Further, a user interface can allow a user to watch changes in the values of variables as instructions are stepped through or traced.

The current instruction pointer can be stored in memory, such as, for example, RAM, hard drive, or other memory. Further, the current instruction pointer can be stored, for example, by pushing the current instruction pointer onto a stack.

The method can further include executing a second block of instructions in the controlled environment, following storage of the current instruction pointer 140. For example, the method can further include storing a next instruction pointer, after executing the first phantom instruction block. In this case, the program loader selects a second block of instructions of the program based at least in part on the stored next instruction pointer, and the selected second block of instructions is manipulated to provide a second phantom instruction block. This manipulation of the selected second block includes copying at least a portion of the selected second block to form the second phantom instruction block, and executing the second phantom instruction block in the controlled environment. The selected second block of instructions includes one or more instructions. The manipulation of the selected first and second blocks can also include marking the first and second blocks as read-only, or logically modifying at least a portion of the first and second phantom instruction blocks, or both. In turn, logically modifying at least a portion of the first and second phantom instruction blocks can include any one or combination of inserting program logic into the first and second phantom instruction blocks, deleting program logic from the first and second phantom instruction blocks, and changing program logic in the first and second phantom instruction blocks.

According to a further exemplary aspect of the invention, the operating system can include a thread-spawning routine having at least one block of instructions, and therefore, the method can further include actions for accounting for thread spawning, which can cause a loss of execution control. Accordingly, the method can further include actions that logically mirror other actions in execution of the method, starting from initiation of execution of the operating system. Thus, the method of the invention can also include inserting second redirection logic at a beginning of the thread-spawning routine that directs execution control to the program loader, and executing the thread-spawning routine.

Alternatively, or in addition, the operating system can include an exception handling routine having at least one set of instructions. Accordingly, the method of the present invention can further include actions for accounting for exceptions, which can also cause a loss of execution control. Accordingly, the method can further include inserting second redirection logic, at a beginning of the exception handling routine, that directs execution control to the program loader, and executing the exception handling routine.

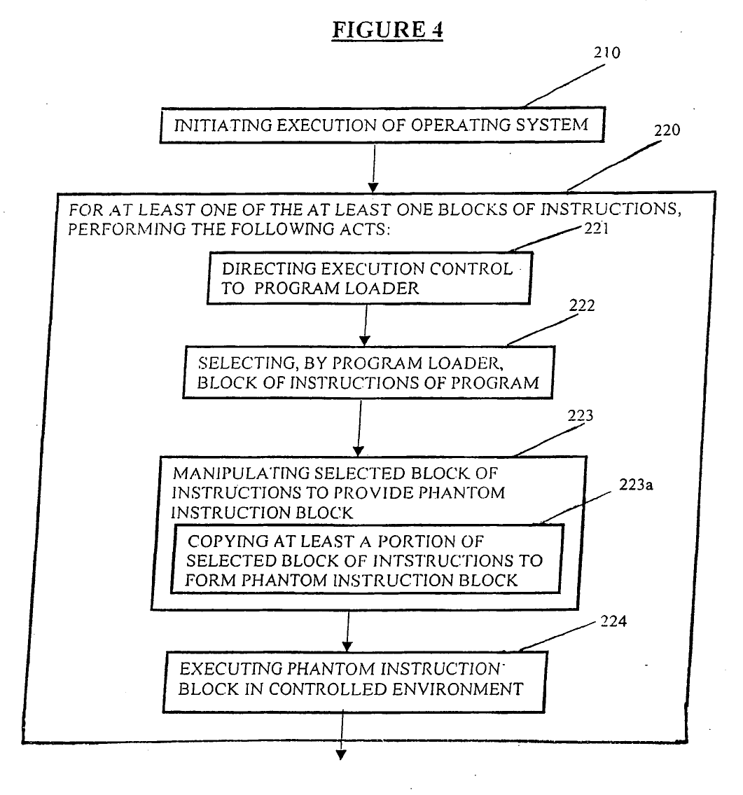

As shown in FIG. 4, according to another exemplary aspect of the present invention, a method of executing, in a controlled environment, a program having at least one block of instructions includes initiating execution of an operating system with which the program is adapted to execute 210, and performing a number of subsequent actions for at least one of the blocks of instructions 220. These actions include directing execution control to a program loader 221. Also, a block of instructions of the program is selected by the program loader 222, and the selected block of instructions is manipulated to provide a phantom instruction block 223. This phantom instruction block is executed in the controlled environment 224. The manipulation of the selected block of instructions includes copying at least a portion of the selected block to form the phantom instruction block 223a. Each selected block includes at least one instruction.

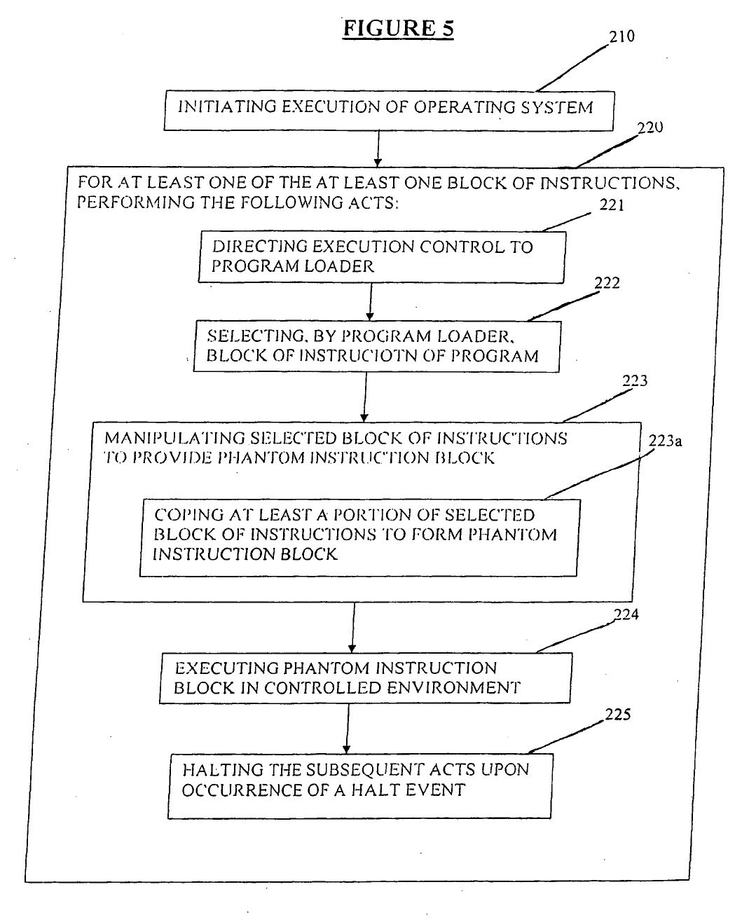

As shown in FIG. 5, the subsequent actions can also include halting further actions based on the occurrence of a halt event 225, which can include, for example, a stop command, and a logical condition within program logic (for example, WHILE NOT END OF FILE).

The manipulation of the selected block of instructions can also include marking the selected block as read-only, or logically modifying at least a portion of the phantom instruction block, or both. In turn, logically modifying at least a portion of the phantom instruction block can include any one or combination of inserting program logic into the phantom instruction block, deleting program logic from the phantom instruction block, and changing program logic in the phantom instruction block.

Execution of the phantom instruction block in the controlled environment can include any one or combination of monitoring execution of the phantom instruction block, preventing at least a first portion of the phantom instruction block from executing, and modifying at least a second portion of the phantom instruction block before the second portion executes. The controlled environment can include a user interface by which a user can execute and monitor execution of the phantom instruction block, such as monitoring the values of system and/or program variables and states, and system memory, as well as other system or program states and conditions. According to an exemplary aspect of the invention, a user interface can provide a “debugging” environment, with which a user can execute, monitor, modify and/or prevent execution of one or more instructions contained in a phantom instruction block. According to another exemplary aspect of the invention, a user interface can allow a user to trace and step through, on an instruction-by-instruction basis, the one or more instructions contained in a phantom instruction block. Further, a user interface can allow a user to watch changes in the values of variables as instructions are stepped through or traced.

This method of the present invention can also include inserting, within the program, first redirection logic that directs execution control to the program loader, and executing the program. In this case, the subsequent actions can further include storing a respective current instruction pointer, such that the program loader selects the block of instructions of the program based at least in part on the stored respective current instruction pointer.

According to another exemplary aspect of this invention, in connection with an earlier described exemplary aspect, the operating system can include a thread-spawning routine having at least one set of instructions, wherein a set of instructions can include as few as a single instruction. Thus, this method of the invention can also include inserting, at the beginning of the thread-spawning routine, second redirection logic that directs execution control to the program loader, and executing the thread-spawning routine. In this case, this method of the invention can also include performing additional actions for at least one set of instructions. These additional actions can include redirecting execution control to the program loader. Also, a set of instructions of the thread-spawning routine is selected by the program loader, and the selected set of instructions is manipulated to provide a phantom instruction set. The phantom instruction set is executed in the controlled environment. Each selected set of instructions includes at least one instruction, and manipulating the selected set of instructions includes copying at least a portion of the selected set of instructions to form the phantom instruction set.

Alternatively, or in addition, the operating system, in accordance with a previously described exemplary aspect of the present invention, can include an exception-handling routine having at least one set of instructions. Thus, the method of the invention can also include inserting, at a beginning of the exception-handling routine, additional redirection logic that directs execution control to the program loader, and executing the exception-handling routine. In this case, the method of the invention also includes performing subsequent actions for at least one set of instructions. These subsequent actions can include redirecting execution control to the program loader. A set of instructions of the exception-handling routine is selected by the program loader, and the selected set of instructions is manipulated to provide a phantom instruction set. The phantom instruction set is executed in the controlled environment. Each selected set of instructions can include as few as a single instruction, and manipulating the selected set of instructions includes copying at least a portion of the selected set of instructions to form the phantom instruction set.

According to yet another exemplary aspect of the present invention, the manipulation of the selected block can also include determining if the selected block is represented by current data stored in a cache. If the selected block is not represented by the current data stored in the cache, at least a portion of the selected block is copied to form the phantom instruction block, and additional data representative of the formed phantom instruction block is added to the cache. On the other hand, if the selected block is represented by the current data stored in the cache, the current data representative of the selected block of instructions is referenced to provide the phantom instruction block. The manipulation of the selected block can also include determining if the selected block of instructions invariably directs execution control to a different block of instructions represented by the current data stored in the cache. If it is determined that the selected block of instructions invariably directs execution control to the different block of instructions, redirection logic is inserted into the selected block that directs execution control to a cached phantom instruction block representative of the different block.

It should be noted that the present invention can be further embodied as an apparatus, or as a computer-readable medium, each of which is based on the process embodiments described herein.

In the foregoing written description, the invention has been described with reference to specific embodiments thereof. However, it will be evident that various modifications and/or changes may be made thereto without departing from the broader spirit and scope of the invention. Accordingly, the specification and drawings are to be regarded in an illustrative and enabling, rather than a restrictive, sense.

Kernal Mode

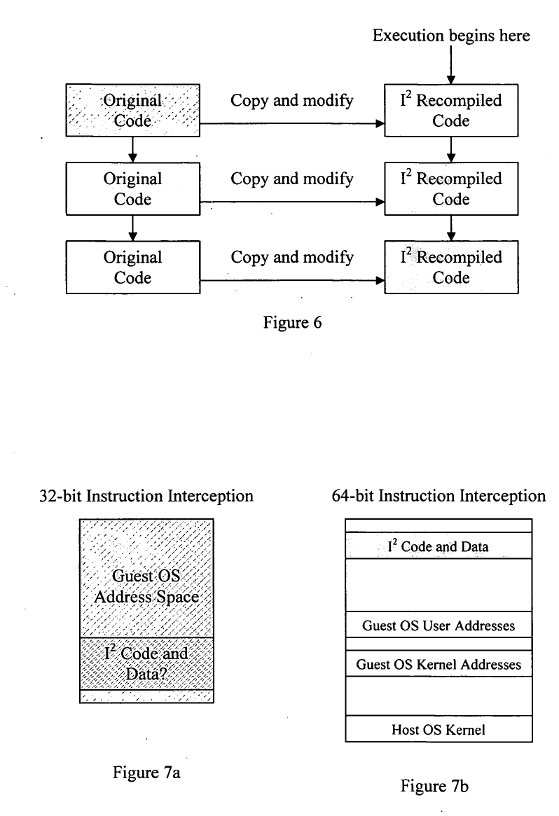

A kernel-mode Instruction Interception technique instruments code at runtime into a buffer and runs this instrumented code instead of the original code. As shown in FIG. 6, each instruction to be executed on the CPU is copied, and possibly modified, to a new location in memory. Control is then passed on to the copied instructions. To maintain control of execution, all control transfer instructions are modified first to copy the instructions (and again possibly modify them) and then transfer execution to those copied instructions. The decision to modify and how to modify is made by an extensible plug-in system that allows arbitrary instrumentation to be attached to any desired instruction. This instrumentation can range from breakpoints to data flow analysis, and can be fully customized by adding a dynamically linked library file into the Instruction Interception path.

The existing feature set of certain user-mode instruction intercept techniques, such as that disclosed in U.S. patent application Ser. No. 10/390,397, can be carried over directly to kernel-mode Instruction Interception. However, as kernel-mode operation must virtualize the entire system, several extensions are necessary.

First, the operating system running under kernel-mode Instruction Interception expects to have full control over the system, including all of a 32-bit virtual address space. To allow kernel-mode Instruction Interception to reside in the virtual address space without interfering with the guest OS, it preferably will run in the 64-bit mode found on, for example, more recent x86 CPUs from AMD and Intel, as shown in FIG. 7. As shown in FIG. 7a, trying to emulate a full 32-bit system using 32-bit address space can create conflicts. For example, there is no place to put the Instruction Interception code and data without interfering with the guest operating system. On the other hand, the 64-bit implementation provides plenty of room to fit the guest operating system, and allows kernel-mode Instruction Interception to be run inside another operating system, as shown in FIG. 7b. Thus, multiple copies of the emulated address space can be cached inside the full host operating system's address space, and removes any need for complex runtime relocation or specially designed drivers running on the host operating system.

Note that in preferred embodiments there will be two copies of the guest OS address space in kernel-mode Instruction Interception: one for user pages and one for kernel pages. This allows very fast switching between user mode and kernel mode, as only the base of the emulated virtual address space needs to be updated. If this feature is not included, much of the address space must be remapped.

Because the 64-bit mode is just an extension to the previous x86 architecture, 32-bit instructions can easily be translated into 64-bit equivalents during the recompilation phase. Register pressure is a non-issue as there are 8 additional general purpose registers available in 64-bit mode. All general purpose registers on the emulated 32-bit environment will be cached in 64-bit registers during code execution. However, memory accesses will need to be modified to redirect to the location of the virtualized address space within the larger 64-bit address space. For example, the following instruction:
mov eax, [ebx+4]
   would be translated to the following 64-bit instruction, where r13 is a cached pointer to the start of the virtualized address space:
mov eax, [r13+rbx+4]

Notice that ebx was “promoted” to the 64-bit rbx, which would seem at first to introduce an unknown offset in the upper 32 bits. However, the 64-bit extensions specify that any 32-bit operation on a register automatically clears the upper 32 bits to zero. Because the virtualized CPU will never be executing 64-bit code, the upper 32 bits will always be zero, and thus the promotion to the 64-bit rbx is always safe.

In some cases an instruction will have to be split into multiple instructions. For example, when trying to recompile this instruction:
mov eax, [ebx+esi*4]
   only two registers may be used at a time in any x86 addressing mode, so the addition of r13 (start of the virtual address space) must take place elsewhere. Because there are additional registers in 64-bit that the virtualized 32-bit CPU is unable to see, this can be done with a scratch register. For example:
lea r11d, [rbx+rsi*4]
mov eax, [r13+r11]

Note that the case where the referenced segment does not point to a flat segment (base of zero, limit of entire 32-bit address space) will require the addition of the segment base into the final offset and possibly a compare with the segment limit. Because of the additional scratch registers and the relative infrequency of this occurrence in modern operating systems, this should not have a negative impact on performance.

Some memory locations, however, cannot be so easily translated. Certain hardware devices map their I/O into the address space. For example, the VGA controller maps a 128 kilobyte area for communicating with the CPU. In many cases, a read from or write to one of these memory locations produces special side effects on the device. If the device is to be emulated, the memory access must be passed through a device emulation layer rather than acquiring direct access to an area of RAM, but this should be done in a way that does not slow down typical RAM access. In order to do this, the area of device I/O memory is marked as “no access” so that any attempt to read from or write to the device will cause an exception. The exception handler is responsible for passing on the access to the device emulation layer.

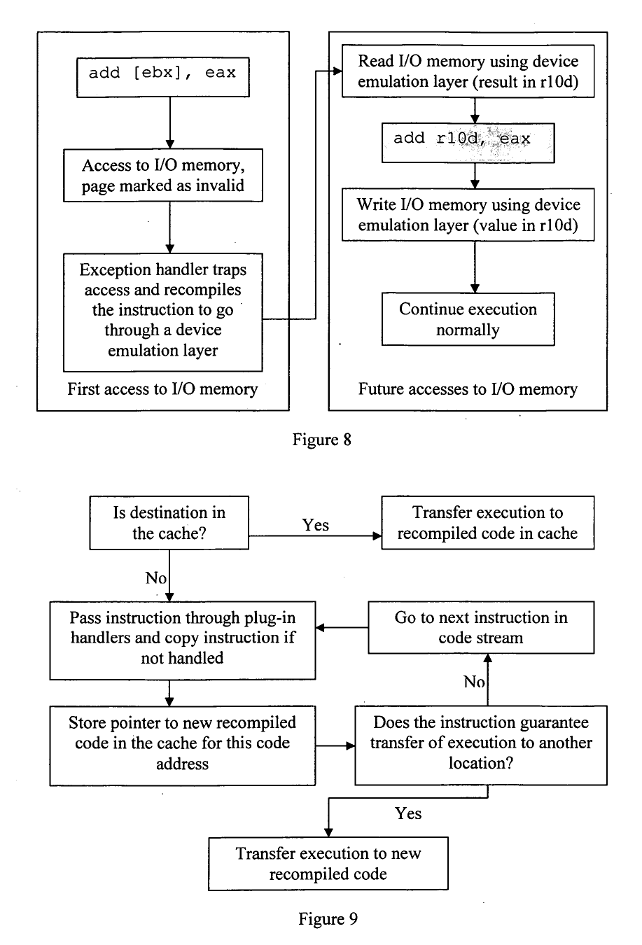

This approach, however, can have severe negative performance implications with respect to code that performs heavy device I/O functionality (for example, screen updating routines). In order to mitigate the problem, the code accessing the device will be recompiled in the exception handler to call into the device emulation layer directly instead of attempting to access the memory location (which would trigger the exception handler again). While slower than a direct access, this process is much faster than using an exception handler. Note that only the code that accesses devices will be affected, so nearly all code in the system will still run at full speed. FIG. 8 shows an example of this method of handling memory-mapped I/O. As shown, the first access to I/O memory (add [ebx], eax) is marked as invalid. In this case, the exception handler traps access and recompiles the instruction to go through a device emulation layer. In future accesses to I/O memory, the memory is read using the device emulation layer. In the case of this example, the result is r10d, and the resulting access instruction is add r10d, eax. I/O memory is written using the device emulation layer, that is, the value in r10d, and execution continues normally from that point.

Page tables preferably will be treated as device I/O and use this same method, as the real page table is in 64-bit and does not have the same format. Accesses to the page table will be emulated and the new mapping will be loaded into the host virtual address space.

As in user-mode Instruction Interception, a cache of recompiled code will be kept to speed up execution. When a block of code is recompiled, the result is replaced in the code cache. Control transfer instructions will look for the destination in the code cache first instead of recompiling it. Direct control transfers can be recompiled to go directly to the recompiled destination. In this way, most code can execute at near native speed. For example, FIG. 9 is a diagram of an exemplary control transfer and cache operation under Instruction Interception. As shown, if the destination is in cache, execution is transferred to recompiled code in cache. If the destination is not in cache, instructions are passed through plug-in handlers and instructions that are not handled are copied. The pointer is stored to new recompiled code in the cache for this code address. If the instruction guarantees transfer of execution to another location, execution is transferred to the new recompiled code. If the instruction does not guarantee transfer of execution to another location, the next instruction in the code stream is selected, and instructions are passed through plug-in handlers as before.

Kernel-mode Instruction Interception, however, also has to be concerned with 16-bit mode versus 32-bit mode. In some cases, rapid switching between 16-bit and 32-bit modes is possible. With a single common code cache, the entire cache would have to be flushed on every mode switch, as the code executes differently depending on the current mode. A cache flush is an expensive operation, so it should be avoided when possible. An alternative is to use a number of caches. For example, five caches can be kept:
A cache for 16-bit code and a 16-bit stack;
A cache for 16-bit code and a 32-bit stack;
A cache for 32-bit code and a 16-bit stack;
A cache for 32-bit code and a 32-bit stack, with non-flat segments (that is, the base address is not zero or limit is not 4 GB);
A cache for 32-bit code and a 32-bit stack, with flat segments.

Most modern operating systems only use the fifth cache, so this model will not unnecessarily increase memory usage. The distinction between flat and non-flat segments is an optimization to eliminate the need to add in the segment base during memory accesses (64-bit mode does not support non-flat segments). Flat segments will rarely be found in 16-bit mode so the distinction is only made for 32-bit mode. Note that the FS and GS segments are disregarded in the check for flat segments, since many operating systems use these as “pointers” to thread and process information blocks. Use of these two segments will always emit code to add in the segment base during memory accesses.

Recompiled code kept in the cache must always be kept coherent with the original code present in the emulated memory space. In order to do this, the Instruction Interception process must be notified when the code has changed. As in user-mode Instruction Interception, two detection methods preferably will be utilized:
When a block of code is cached, the page that it resides in will be marked as read-only. If the emulated OS tries to write to that memory, it will cause an exception. The exception handler will flush the code out of the code cache and it will be recompiled the next time it is executed.
During recompilation, a block of code is emitted before each instruction to read the original code and ensure that memory still holds the same instruction that was recompiled. If the instruction is different, the code is flushed from the cache and recompiled with the new instruction.

The first method is much faster in nearly all cases, except in blocks of code that perform heavy self-modification or writes to data in the same page as code (for example, a large amount of code execution near the top of the stack). The exception handler should detect blocks of heavy modification and switch over to the second method after a certain threshold to avoid exception overhead.

It is contemplated that kernel-mode Instruction Interception can be implemented in different embodiments. For example, at least the following two embodiments are contemplated.
An embodiment that runs as a user-mode application within a 64-bit host OS. With a Linux host OS, no drivers need to be installed on the host system (Windows® is not able to do virtual memory aliasing and has a large mapping granularity, so it requires kernel driver support). All hardware is either emulated or passed through to a plug-in (which may pass to the real hardware if desired).
An embodiment that runs as a standalone bootable 64-bit operating system. This version gives the emulated OS full access to all hardware except those components that could be used to disable kernel-mode Instruction Interception and those that require virtualization (such as the interrupt controller). A second machine (can be 32-bit) connected with a null-modem cable would be necessary as the emulated OS would have full access to the display. This version is necessary if the target requires hardware that cannot be shared with a host OS (such as a graphics accelerator).

Kernel-mode Instruction Interception, as it operates at the system level, can run and instrument any operating system of choice. Many of the constructs that require attention in user-mode Instruction Interception are automatically handled in kernel-mode Instruction Interception. For example, the emulated operating system is responsible for implementing threads and processes. The code that switches from one thread to another simply changes the register state and will be intercepted by kernel-mode Instruction Interception, so a thread switch is nothing more than another sequence of instructions and is intrinsically handled.

However, many times it is useful to work with the high-level notion of a thread or a process, so operating system specific handling of them will be needed for easier debugging. This handing will be represented with a plug-in, so debugging support for any desired operating system can be added.

Plug-Ins

Code Transformation

Many modern applications, including the payloads of malicious mobile code, utilize code obfuscation that makes binary-only analysis during red-team projects very difficult. With the per-instruction instrumentation capability of Instruction Interception technology, this difficulty can be mitigated effectively. By coupling the run-time transformation of obfuscated code and a dynamic control flow graphing capability (also built on top of Instruction Interception), the obfuscated code can be drastically simplified and made into something easy to follow and understand. Instruction Interception's dynamic run-time nature can also allow many types of analysis to be performed directly on obfuscated code where static techniques would fail.

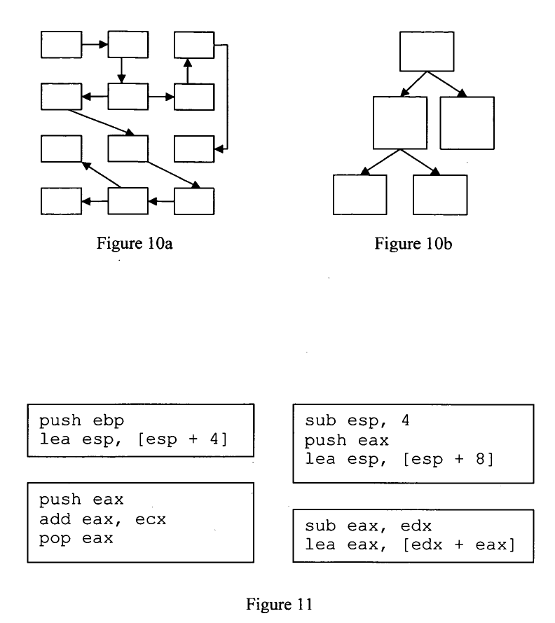

One obfuscation technique is the heavy use of jump instructions to spread out a function's code over the entire binary. Per-instruction code transformation can eliminate these jump instructions and bring blocks of code back together. This reduces the number of basic blocks that must be tracked and allows the user to see related code in a much more concise manner. See FIG. 10 for an example of the transformation of simple control flow obfuscation. FIG. 10a shows obfuscated code, in which basic blocks are split by frivolous jumps and code is scattered around the binary. FIG. 10b shows transformed code, in which basic blocks have been merged back together and the flow is easier to follow.

Many implementations of this technique also jump into the middle of another instruction's encoding. This confuses most disassemblers and causes them to produce incorrect output. However, as Instruction Interception looks at the instructions actually executed at run-time, it is automatically able to recover the actual code stream regardless of anti-disassembly tricks such as these.

Another common obfuscation technique is the introduction of groups of instructions that have no effect on the state of the program. These sequences typically affect only the CPU flags or unallocated portions of the stack, which are quickly overwritten by the algorithm being obfuscated. Many of these can be found and removed with simple basic block analysis techniques (note that the elimination of frivolous jump instructions as in the previous paragraphs might be required in order to resolve the basic blocks). See FIG. 11 for some examples of this, in which x86 “do nothing” code sequences are used for obfuscation.

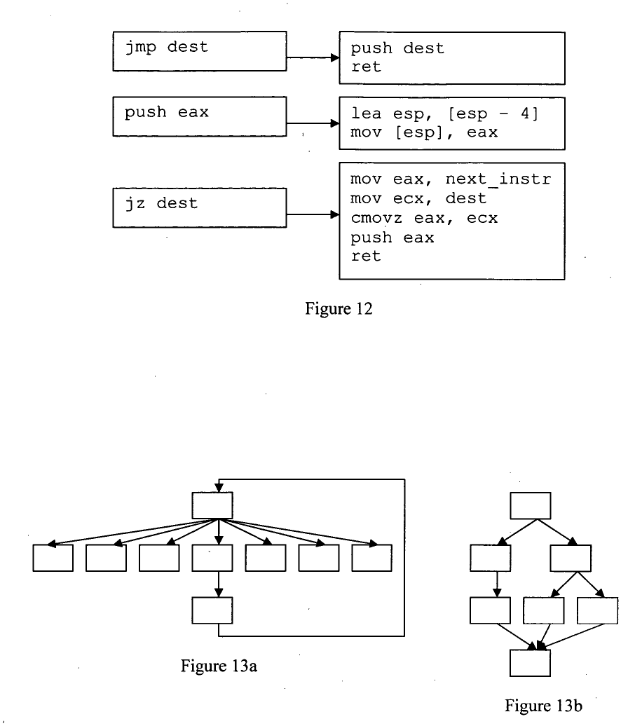

Instructions can also be replaced with obscure equivalent instruction groups. For example, a jump instruction can be replaced with a push followed by a procedure return, as the return instruction looks at the top of the stack for its destination. These can also be found with basic block analysis techniques, but are transformed back into their more traditional forms rather than being removed. See FIG. 12 for examples of this type of transformation, obscure x86 code equivalents.

More complex control flow obfuscation techniques are also used, such as code flattening. This takes the control flow of a function and transforms it into a large switch-style statement in a loop. This transformation makes it extremely difficult to follow the flow of the function in a graph or in static disassembly. However, per-instruction instrumentation can rewrite the transfer to a switch-style construct to go directly to the next destination in one operation. By rewriting it in this way, the dynamic control flow graphing capability can resolve the original flow, as the origins and destinations are once again connected. See FIG. 13 for an example of transformation of flattened code. FIG. 13a shows that when code flattening is applied, control flow in the graph can no longer be followed, and static analysis becomes nondeterministic. However, as shown in FIG. 13b, in the transformed code, control flow is easy to follow and analyze.

As seen above, many common types of code obfuscation can be reversed by monitoring the code stream and simplifying the code at the per-instruction level during runtime. Simple transformations can allow for deeper levels of analysis that can in turn allow more complex obfuscations to be made easier to understand. Analyzing an application with new types of obfuscation is also made possible by using the extensible plug-in architecture provided in Instruction Interception. By using per-instruction transformation and dynamic analysis techniques, significantly more information can be uncovered from an obfuscated binary than can be found using traditional debuggers or static analysis techniques.

Dynamic Graphing

Instruction Interception technology allows customized instrumentation to be added to any set of instructions in an executing program. With this, a dynamic code visualization system is created. In some respects, it is similar in appearance to static control flow graphing techniques found in conventional products, but builds the graph dynamically as the program executes and integrates run-time information into the display.

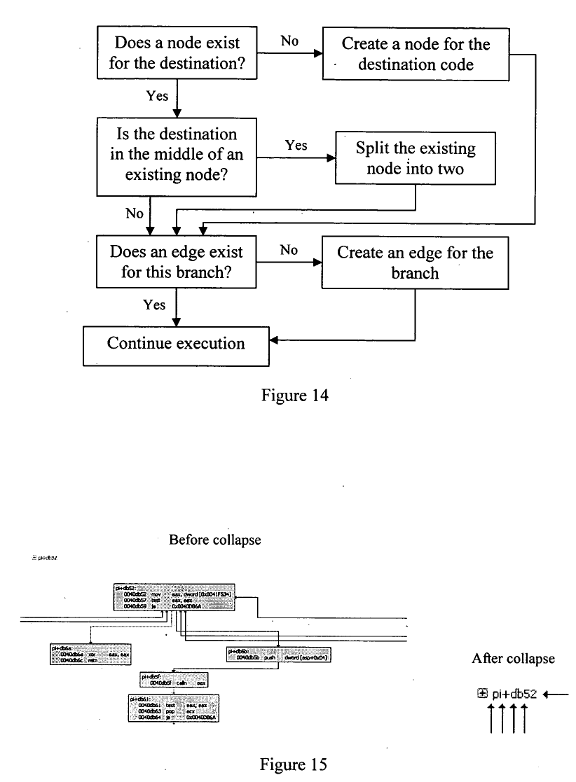

Dynamic graphing is accomplished by intercepting all branching instructions executed by the application. As shown in FIG. 14, when a branching instruction is executed, a node and edge for the destination block of code are created if they do not already exist. Nodes are initially created to contain all instructions from the starting address to the next branching instruction. Conditional branches will also terminate nodes in this way, but create two edges and two destination nodes. If any destination is in the middle of an existing node, the node is split into two so that every node is a basic block of execution.

The user's view of the graph is automatically updated with any new content when execution stops at a breakpoint, at the end of a stepping operation, or at user request. For efficiency, updates preferably are queued up during execution and sent to the debugger in one batch during a break-in event.

Dynamic graphing has several advantages over traditional static graphing. Packed code or code that is constructed on the heap at run-time will not show correctly in a static graph. Dynamic graphing, on the other hand, looks at the code that is actually executing on the CPU, and thus handles code constructed at runtime without issue. Also, dynamic graphing can introduce code coverage or data flow information directly into the graph. This information can be displayed to the user as color coding or tooltips, or can be used to simplify the graph to the portions being actively investigated.

Other enhancements to traditional code visualization are made, such as the merging of a function-level view and a block-level view. With most code graphs, viewing many functions in the same graph can cause the code flow within functions to become hard to follow. To solve this problem, function grouping is introduced. This technique groups all basic blocks belonging to a single function into a common unit. This functional unit can then be collapsed or hidden. FIG. 15 shows an example of function grouping and collapsing.

Basic blocks within a functional unit are arranged inside a designated, for example, colored, area representing that function. Functions are then arranged in whole units as in a typical function-level graph view. This not only tidies up the display of large graphs, but also significantly reduces the computational complexity of graph layout. It also removes the need for both a block-level graph and a function-level graph, as a graph with all functional units collapsed is equivalent to a function-level graph. Any function can then be easily expanded to reveal the details of the associated basic blocks.

In addition to function collapsing, functions can be hidden entirely. This removes the nodes and edges from the graph view, but does not remove the information associated with them. The function can be made visible again by using, for example, a function list dialog box. Also, a node that branches to or from the hidden function will show this fact inside a tooltip when the mouse hovers over the node. This keeps information such as call destinations readily accessible even if the destination is hidden. Additionally, entire modules can be hidden or shown at once, with the typical set of commonly-used APIs being hidden by default in order to simplify the graph and place the focus on application code rather than library code. This list of modules hidden by default can be configured by the user.

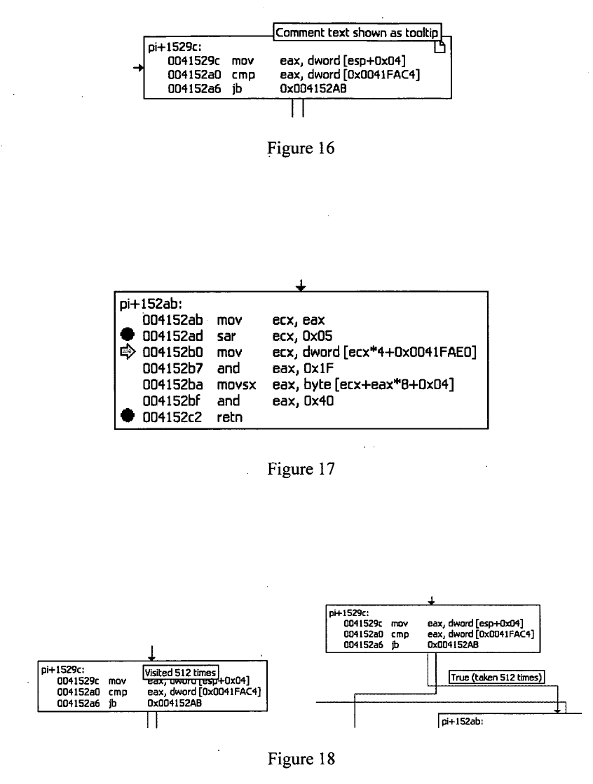

Arbitrary comments can also be added to any basic block. These will show up in the graph view as a note icon and in the traditional disassembly listing. The comment text is displayed when the mouse hovers over the note icon, as shown, for example, in FIG. 16.

Because of the runtime nature of dynamic graphing, it is also possible to integrate debugging features directly into the graph. For example, FIG. 17 shows breakpoints and single stepping within the graph view. Breakpoints can be set or removed by simply clicking on the instruction in the graph. Context-sensitive menus allow easy navigation between traditional debugger views and the dynamic graph view. The current execution state is shown in the graph with an arrow pointing at the current instruction. Stepping through the application's code within the dynamic graph view is also possible, with the user's view automatically following the current instruction arrow. If the new location is new code or references new code, nodes and edges for this code are dynamically added to the graph automatically.

Run-time code coverage information is also integrated directly into the graph. By default, covered code is preferably shown in a different color so that the active path is easily seen, but a context menu option is available to hide all unvisited code. Also, every basic block and edge has an execution count associated that preferably is shown as a tooltip when the mouse hovers over a node or edge, as shown in FIG. 18. This execution count information can in turn be used to color code the graph by frequency of execution for performance analysis.

Many types of run-time information can be integrated, including the results from dynamic data flow analysis and performance monitoring. Visualization elements can include color highlighting, tooltips, and icons. A set of APIs will be provided that will allow plug-ins to add new uses of visualization to the dynamic graph view. By integrating these APIs with the per-instruction instrumentation capabilities of the Instruction Interception technology, entirely new classes of graph-based code and data visualization are possible.

Synthetic CPU

Shrink-wrapped software and most electronically-distributed software is provided with a listing of explicit minimum requirements. This allows the end user to determine if the product will run on his system. Minimum requirements are determined by keeping older computers around, observing the performance, and making educated guesses. With customizable instruction-level instrumentation, extensions to Instruction Interception technology can revolutionize this process, and even enable error checking that is not possible on down-level x86 CPUs. This extension allows the following:
Emulation of the performance of CPUs slower than the host CPU
Ability to emulate instructions not supported on the host CPU
Ability to detect and/or disable instructions not supported by the target CPU, including those that perform an operation different from the one requested instead of triggering an exception.

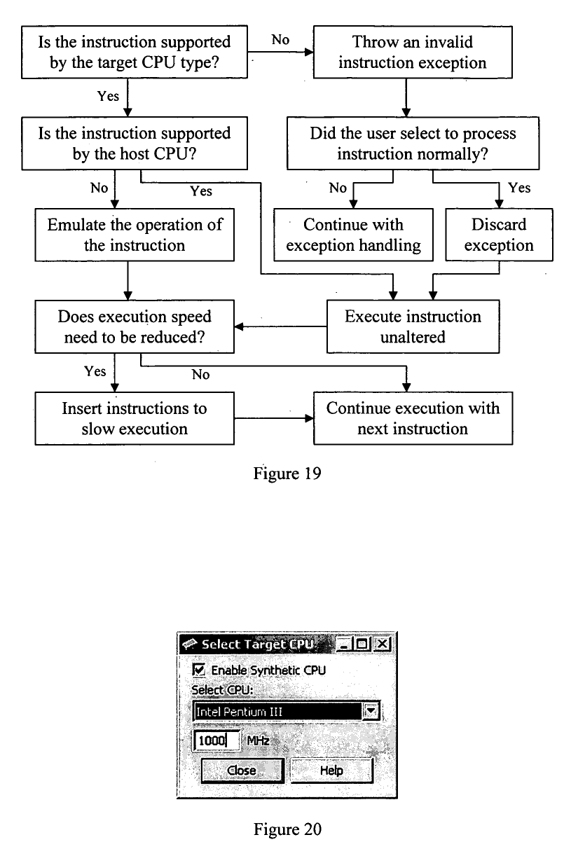

These features are implemented as an Instruction Interception plug-in that monitors the instructions executed by the application under test. Instructions that are not supported on the host or target CPUs will be intercepted and altered to perform the same actions as on the selected target CPU type. Instructions can also be inserted into the code stream to throttle the speed of the application to match that of another CPU. FIG. 19 is a diagram showing the handling of instructions. As shown, it is first determined whether the instruction is supported by the target CPU type. If it is, it is then determined whether the instruction is supported by the host CPU; if so, the instruction is executed unaltered. However, if the instruction is not supported by the target CPU type, an invalid instruction exception is issued, and it is determined whether the user intended to process the instruction normally. If so, the exception is discarded and the instruction is executed unaltered. If not, exception handling continues. If, on the other hand, the instruction is supported by the target CPU type but not by the host CPU, the operation of the instruction is emulated. If the execution speed needs to be reduced (in any case), instructions are inserted to slow execution; otherwise, execution is continued with the next instruction.

The user is able to select from a predefined set of CPUs or from custom CPUs the user has created. When a CPU is selected, the application will execute as if it were running on this new target CPU. FIG. 20 shows an exemplary CPU-selection user interface.

As seen above, this plug-in to Instruction Interception technology can alter the speed of the application. A database of CPUs and their performance rating in MIPS (millions of instructions per second) will be kept. When the application under test is executed, it determines the speed of the host CPU in MIPS and computes the number of instructions the host CPU can execute for each instruction the target CPU executes. Instructions are then inserted into the application under test to slow it down to the speed requested by the user.

Note that Instruction Interception technology has overhead associated with most branching instructions, and thus the application typically executes at 50% to 75% speed. This overhead must be taken into account when inserting instructions to slow down execution. Also, targeting a CPU speed that is more than about 50% to 75% of the host's speed can cause inaccuracies, as execution may not be fast enough even without throttling instructions. The user will be warned if this is attempted.

Users can also define custom CPU types based on their MIPS rating and the set of supported instructions. This allows users to target new CPUs or non-mainstream CPUs such as those used in embedded development. A simple utility application is also provided to automatically generate the information required for a new CPU type when executed on a machine with that CPU.

During execution the application might attempt to execute an instruction that is not supported on the CPU to be simulated. In this case, a standard invalid instruction exception will be generated and the event will be logged. The user can pass the exception on to the application, or ignore it and instead emulate the instruction's behavior (allowing the user to continue testing the application). Note that through some issues with the design of x86 CPUs, some instructions might execute without causing exceptions on CPUs that do not support them. The CPU will silently compute a wrong answer, and that might or might not cause an exception. These cases can now be detected and brought to the user's attention.

It is also possible to encounter instructions that the host CPU does not support (for example, in the case of a Pentium III with the target CPU set to a Pentium IV). In this case, the instruction will be emulated automatically. This is completely transparent to the application under test. This extends the life of costly investments in PC hardware and allows developers to experiment with new hardware before it becomes widely available. Additionally, new instructions can be designed and tested without requiring integration into hardware by using the Instruction Interception plug-in architecture.

Dynamic Decompilation

Part 1—Dynamic Analysis in Decompilation

Instruction Interception technology allows customized instrumentation to be added to any set of instructions in an executing program. With this, the target locations of branching instructions can be documented each time a branching instruction is executed. These locations are then provided as inputs to a static decompiler along with the executable image to produce C and/or C++ source code corresponding to the functionality of the executable.

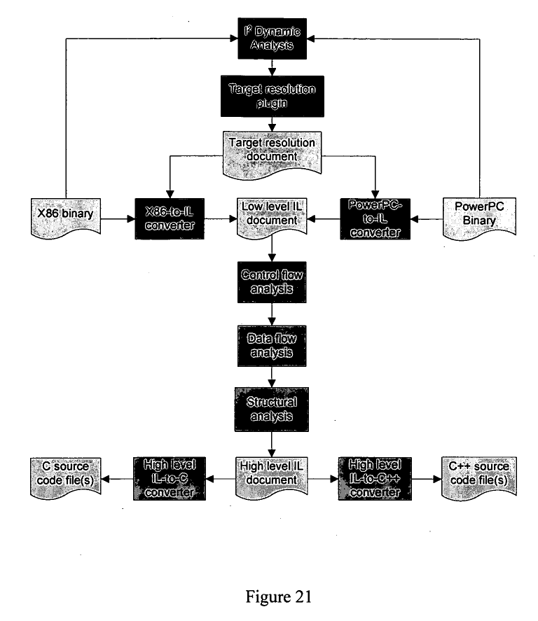

A plug-in for Instruction Interception writes destinations of branching instructions to a text file along with the address of the branching instruction. Once the user is done executing the application under Instruction Interception, he will execute the decompiler, passing to it the executable image and the text file provided by the plug-in as arguments. As a part of the decompiler, there will be a conversion utility that takes the executable image and the text file from the plug-in and produces an intermediate language (referred to herein as the low-level IL) with the destination locations of the branching instructions resolved. Once this low-level IL document is constructed, techniques and algorithms from previous research on static decompilation will be used to convert the low-level IL into a higher-level IL and ultimately to C or C++ source code documents. The overall process of the decompilation is shown in FIG. 21.

Integrating dynamic target resolution into existing static decompilation techniques provides several advantages over static-only decompilation. Current static decompilers such as the Reverse Engineering Compiler (REC) and Boomerang can successfully decompile executable images into higher-level languages such as C or C++ in most cases. Cases where static-only decompilers fall short are in resolving target locations of jump tables and virtual function tables (vtables) as well as any other branching instruction having an actual target that is dependent on a particular register value. The reason for this is that both jump tables and vtables rely on the runtime value of a particular register to obtain the real address to jump to. For example, a typical jump to a jump table address looks like the following on x86:
jmp<const>+4*ebx
   where <const> is some constant defined by the compiler and ebx is a register value. A typical vtable jump looks like the following on x86:
call ecx+16
   where ecx is a register value. The values in the ebx and ecx registers in the above examples cannot be determined at any other time than runtime, so static decompilers can not resolve all the possible destination addresses. Often static decompilers handle this by allowing the user to figure out possible target locations based on human research of the application's behavior. Dynamic target resolution, however, can determine and report these values at runtime, giving the static decompilation much more information than without dynamic analysis and without involving a human's research skills.

A second shortcoming of existing static decompilers is failing on packed executables. In these instances, nearly the entire executable is data with a small algorithm existing in the code section to unpack the data and begin executing it. Static decompilers will not have any idea what code will be executed once it is unpacked. Since Instruction Interception's dynamic analysis sees the instructions executing after the unpacking, it can provide the user with accurate information about the executable's behavior.

A third shortcoming of existing static decompilers involves executables using self-modifying code. In this case, executables change themselves to execute code at runtime other than the code that can be analyzed statically. Instruction Interception is able to see the actual executed code and can provide accurate information to the decompiler. Instruction Interception provides a perfect platform to add this dynamic analysis, which can solve the capability-limiting problems of conventional decompilers that only use static analysis.

The addition of dynamic analysis information via Instruction Interception into the static decompilation process allows information to be obtained that cannot be obtained statically. For example, Instruction Interception allows jump table targets, virtual table targets, packed executables, and self-modifying code to be obtained

Part 2—Object Code Injection

As the static analysis component of the decompiler keeps a machine-updatable view of the entire binary in order to analyze an application, the technology can also be leveraged for the injection of arbitrary code anywhere in the binary. Because traditional object code insertion technologies do not have the full set of information, they leave telltale signs of modification, such as extra sections at the end of the file and jumps to unrelated parts of the file. A binary modified using Instruction Interception object code injection techniques do not leave these signs, and are virtually indistinguishable from a binary compiled from modified source code.

Some functions, however, might need additional human input to convert to proper high-level source code for the source code view. To increase the success rate and decrease the manual effort required to produce correct output, object code injection will generate the result binary from the low-level IL rather than the high-level view. Because the low-level IL comes directly from the machine code, it is very accurate and will convert into an output that is very similar or equal to the original binary.

The object code to inject can be specified in any of the four types of code available, namely, machine-specific assembly code, low-level IL, high-level IL, or C++ code. If the code is specified in one of the higher level forms of code, the code will be translated into low-level IL before the output binary is produced. The low-level IL for each function will be converted back into machine code during the output phase.

The code to insert will be taken on a function-by-function basis. If only part of a function is to be updated, the output of the decompiler in one of the forms above must first be taken from the original function. This output can then be modified in the desired place and re-imported into the binary, overwriting the code of the original function. Note that object code can be deleted as well as inserted with this design. Deleted code will not be present in the output binary. Object code deletion could be used to erase a checksum computation after inserting extra code, for example.

Because this method of object code injection will cause the inserted code to be woven into the existing code as if it were part of the original code itself, it is also ideal for use in adding software protection. Most software protection technologies can be defeated easily if the code performing the protection is isolated within one place in the binary. By weaving the protection into the binary, it is much harder to find and remove. As the interactive decompiler can give a much better understanding of the code in the binary, these tools can be leveraged to create a binary-only post-process software armoring technology that is as difficult to break as technologies applied during the initial compile.

Thus, this aspect of the plug-in provides innovations not present in conventional process. For example, the plug-in allows for rebuilding executables after decompilation and the modification of decompiled code. It also provides for performing binary-only object code injection in-place (rather than at the end of the executable, as mentioned above) for software protection purposes.

We claim:

1. A process of kernel-mode instruction interception on a host CPU, comprising:
copying CPU-executed instructions to respective new locations in memory; and
transferring CPU control to the copied instructions for execution.

2. The process of claim 1, wherein all control transfer instructions are modified to perform the copying and transferring.

3. The process of claim 1, further comprising modifying the copied instructions.

4. The process of claim 3, wherein the copied instructions are modified only when instructed by a process plug-in.

5. The process of claim 3, wherein the copied instructions are modified as directed by a process plug-in.

6. The process of claim 1, run in a 64-bit mode of a CPU.

7. The process of claim 6, wherein the copied instructions include first and second copies of guest operating system address space;
wherein the first copy of guest operating system address space is utilized for user pages; and
wherein the second copy of guest operating system address space is utilized for kernel pages.

8. The process of claim 6, further comprising accessing an I/O device, further comprising
recompiling, in an exception handler, code accessing the device, and
calling into the exception handler directly.

9. The process of claim 1, wherein the copied instructions comprise recompiled code.

10. The process of claim 9, further comprising storing the recompiled code in code cache.

11. The process of claim 10, further comprising looking for a control transfer destination in the code cache.

12. The process of claim 11, further comprising transferring execution to the recompiled code in the code cache, if the control transfer destination is found in the code cache.

13. The process of claim 1, wherein the copying and transferring actions take place on a per-instruction basis at runtime.

14. The process of claim 13, further comprising simplifying the copied code during runtime.

15. The process of claim 1, further comprising intercepting a branching instruction executed by an application and executing the intercepted branching instruction.

16. The process of claim 15, further comprising creating at least one of a node and an edge for a destination block of code for the intercepted branching instruction if either a node or an edge does not already exist.

17. The process of claim 15, further comprising splitting any existing node for a destination block of code for the intercepted branching instruction if the destination block is in the middle of the existing node.

18. The process of claim 1, further comprising selecting a CPU on which to execute the copied instructions.

19. The process of claim 18, further comprising
determining if the instructions are supported by the selected CPU type; and
determining if the instructions are supported by the host CPU.

20. The process of claim 19, further comprising issuing an instruction exception and continuing with exception handling, if the instruction is not supported by the target CPU type.

21. The process of claim 19, further comprising emulating the operation of the instructions, if the instructions are supported by the target CPU type and the instruction is not supported by the host CPU.

22. The process of claim 1, further comprising:
writing destinations of branching instructions to a text file; and
writing the address of the branching instruction to the text file.

23. The process of claim 22, further comprising:
executing a compiler;
providing an executable image; and
passing to the compiler the executable image and the text file.

24. The process of claim 23, further comprising producing intermediate language code based on the executable image and the text file, with destination locations of the branching instructions resolved.

25. The process of claim 24, further comprising converting the intermediate language code to a higher-level source code document.
